(19) United States
(12) Patent Application Publication
(10) Pub. No.: US 2014/0319295 A1
(43) Pub. Date: Oct. 30, 2014

(54) FLEXIBLE AND EXTENDABLE HANGING DEVICE

(71) Applicant: Roman Serebryakov, Altoona, IA (US)

(72) Inventor: Roman Serebryakov, Altoona, IA (US)

(21) Appl. No.: 14/261,535

(22) Filed: Apr. 25, 2014

Related U.S. Application Data
(60) Provisional application No. 61/815,815, filed on Apr. 25, 2013.

(51) Int. Cl. F16M 13/02

(52) U.S. Cl. CPC F16M 13/022
USPC 248/200

(57) ABSTRACT

A hanging device having a plurality of plates pivotally connected to one another. Each plate has at least one ball that extends outwardly from an edge of a plate and is received in at least one aligned socket in the edge of an adjacent plate. The ball frictionally engages the socket such that the plates maintain their position in relation to one another under a load, but are pivotal to one another under manual force.

### CROSS REFERENCE TO RELATED APPLICATION

This application claims the benefit of U.S. Provisional Application No. 61/815,815 filed Apr. 25, 2013.

### BACKGROUND OF THE INVENTION

The invention is directed to a hanging device and more particularly a hanging device for portable devices such as headphones, tablets, phones, and the like.

Hanging devices are well-known in the art. Typically, hanging devices are rigid and limited in their use. Also hanging devices are often made of a material that is capable of scratching or damaging a product such as a pair of headphones. Therefore, there exists a need in the art for a hanging device that addresses these needs.

An objective of the invention is to provide a hanging device that is flexible.

A further objective is to provide a hanging device that is versatile in the manner in which it can be mounted.

A still further objective is to provide a hanging device that reduces the likelihood of scratching or damaging a product.

These and other objectives will be apparent to one having ordinary skill in the art based upon the following written description.

### SUMMARY OF THE INVENTION

A hanging device having a plurality of plates pivotally connected to one another. Each plate has at least one ball that extends outwardly from an edge of a plate and is received in at least one aligned socket in the edge of an adjacent plate. The ball frictionally engages the socket such that the plates maintain their position in relation to one another under a load, but are pivotal to one another under manual force.

### BRIEF DESCRIPTION OF THE DRAWINGS

FIG. 1 is a top plan view of a hanging device;

FIG. 2 is a perspective view of a hanging device; and

FIG. 3 is a side sectional view of a hanging device.

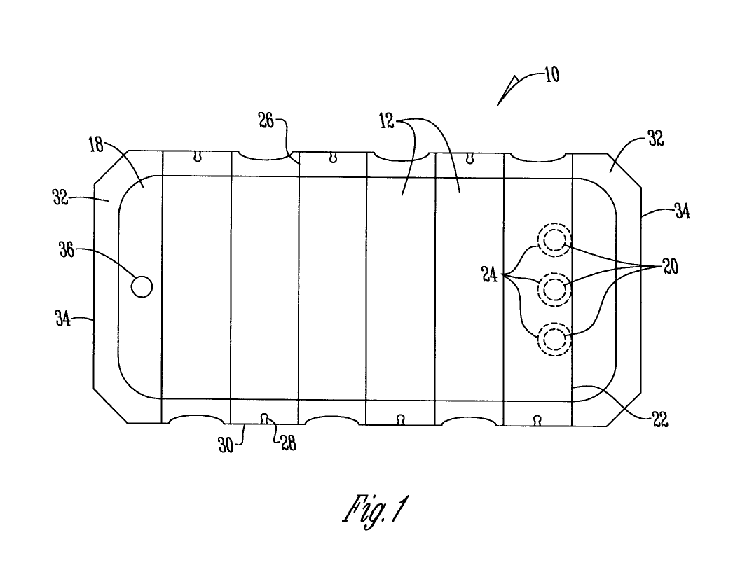

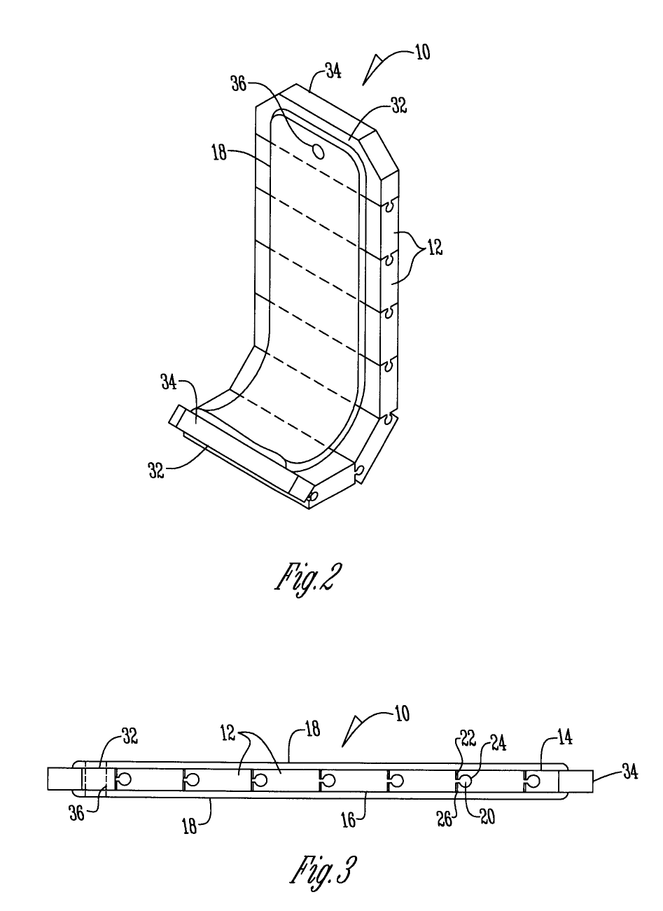

### DETAILED DESCRIPTION OF THE PREFERRED EMBODIMENT

Referring to the Figures, a hanging device 10 includes a plurality of plates 12 made of a durable material. In one embodiment, the upper 14 and lower 16 surface of the plates 12 are concave to better receive a curved or arcuate product. Attached to both the upper and lower surfaces, preferably inward from a peripheral edge of the plate is a soft material 18 which reduces the chance of a product becoming scratched or damaged. The soft material 18 can be modified to different colors, styles, and indicia.

The plates 12 are pivotally connected to one another. Preferably, this is done through a frictional engagement. In one example, each plate has at least one and ideally three balls 20 that extend outwardly from one edge 22 of the plate. The balls 20 are aligned with and received within sockets 24 on the edge 26 of an adjacent plate. The balls 20 frictionally engage the sockets 24 such that the plates 12 maintain their position in relation to one another under the load of a product, but can be pivoted in relation to one another under manual force. The plates 12 are pivotal ninety degrees in either direction from a common plane that they dwell within. The balls and sockets may be of other shapes that create a frictional male/female relationship.

By pulling the plates 12 away from one another, the ball 20 and socket 24 are disengaged to permit the addition, removal and or replacement of plates 12. Also, in one embodiment, a plate 12 has a slot 28 and/or extension on a side edge 30 that permits a user to wrap and secure headphone wires.

At each end are end plates 32 that have a solid end edge 34. Preferably, the end plates 32 have an aperture 36 for mounting to a wall.

In operation, the hanging device 10 is mounted to a hook on a wall such that a portion of the device 10 lies against the wall while a bottom section of plates 12 are pivoted away from the wall and upwardly to form a hook. Alternatively, the device 10 can be hung on an object such as a computer screen by folding one end of the device over the top edge of the computer, extending a center section down the computer screen, and folding the opposite end outwardly and upwardly to form a hook. The hanging device 10 is adaptable to mount on virtually any object and to hold virtually any product.

What is claimed:

1. A hanging device, comprising:
a plurality of plates that are pivotally connected to one another with at least one ball for each plate that extends outwardly from an edge of one plate and is received in an aligned socket on each adjacent plate wherein the ball frictionally engages the socket such that the plates maintain their position in relation to one another under a load, but is pivotal to one another under manual force.

2. The device of claim 1 wherein a material covers at least a portion of an upper and a lower surface of the plurality of plates.

3. The device of claim 1 wherein one of the plurality of plates has a slot in a side edge.

4. The device of claim 1 further comprising a pair of end plates having a solid end edge.

5. The device of claim 4 wherein one of the end plates has an aperature.

6. A hanging device, comprising:
a plurality of plates frictionally and pivotally connected to one another such that the plates maintain their position in relation to one another under a load and pivot in relation to one another under manual force.
